(19) United States
(12) Patent Application Publication
(10) Pub. No.: US 2008/0123830 A1
(43) Pub. Date: May 29, 2008

(54) ASSOCIATION TABLE FOR MULTIPLE DIRECTORY NUMBERS

(75) Inventors: TASVIR SHAH, IRVING, TX (US); RUCHI AGGARWAL, SAN JOSE, CA (US)

Correspondence Address: MARGER JOHNSON & MCCOLLOM, P.C., 210 SW MORRISON STREET, SUITE 400, PORTLAND, OR, 97204, US

(73) Assignee: CISCO TECHNOLOGY INC., SAN JOSE, CA (US)

(21) Appl. No.: 11/428,788

(22) Filed: Jul. 5, 2006

(51) Int. Cl. H04M 3/42

(52) U.S. Cl. 379/201.01

(57) ABSTRACT

A system that associates a particular called number with a particular telephone number on an MDN line. An association table is established which associates particular called numbers with particular numbers on the MDN line. Thereafter calls from the MDN line to any number in the association table results in the call being identified as being from the MDN number associated with the called number in the association table. That is, after a particular called number is associated with a particular MDN number, calls from the MDN line to the particular called number are identified as being from the associated the MDN number. If a called number is in the Association Table, call from that number can be associated with a particular MDN number to provide a distinctive ring tone or other special features.

### FIELD OF THE INVENTION

This invention relates to communication technologies and more particularly to telephone systems.

### BACKGROUND OF THE INVENTION

In general in telephone systems, each particular telephone line has an assigned telephone number. However, in some situation one telephone line may be reached by calling anyone of a plurality of different telephone numbers. In some systems, where multiple numbers are assigned to a single telephone line, each telephone number assigned to a particular telephone line may result in a different sounding ring tone.

Modern VoIP telephone systems frequently include the ability to assign a plurality of telephone numbers to a particular telephone line. Such a configuration can be particularly useful in situations where telephones are connected to the central switch by means of a cable network.

For example, in a home which has a telephone line connected to a cable modem, the telephone line may have three assigned numbers, one number being used for general family use, and one number being used by each of two children. Such systems are frequently referred to as a Multiple Directory Number Systems (MDN) or by other names such as Virtual Number Systems. Herein, the names MDN line will be used to refer to a telephone line that can be reached by a plurality of telephone numbers and the term MDN system will be used to refer to a system with MDN lines. Term main MDN number will be used to refer to the primary telephone number of an MDN line and the other numbers assigned to an MDN line will be referred to as MDN numbers.

One problem that exists with MDN systems is that outgoing calls are always identified as being from the single main MDN number assigned to the telephone line. Thus, when a call is made to a telephone with caller ID, the call always appears to come from the main MDN number assigned to the telephone line.

Other problems can also be created when all outgoing calls appear to come from the single main MDN number. For example, if a called party has an automatic call rejection (ACR) feature, privacy will be assigned to the main MDN telephone number of an MDN line and all calls from that MDN line will be affected.

The present invention provides a mechanism for avoiding some of the problems associated with MDN telephone lines.

### SUMMARY OF THE INVENTION

The present invention allows a user to associate various called telephone numbers with particular telephone numbers on a MDN line. An association table is established which associates particular called telephone numbers with particular telephone numbers on the MDN line. Thereafter calls from the MDN line to any number in the association table results in the call being identified as being from the MDN number associated with the called number in the association. That is, after a particular called number is associated with a particular MDN number, calls from the MDN line to the particular called number are identified as being from the associated the MDN number. The association table can also be used to associate other properties to calls to a particular called phone. Such additional properties can for example relate to indicating a nickname for the calling party or indicating that the call is from an anonymous party.

### BRIEF DESCRIPTION OF THE DRAWINGS

FIG. 1 is an overall system diagram

FIG. 2A is a block diagram of a softswitch.

FIG. 2B is a block diagram of an IP telephone.

FIG. 3 is a block diagram of an association table

FIG. 4 is a block flow diagram of a setup operation

FIG. 5 is a block flow diagram showing how a particular MDN number is associated with a called number.

FIG. 6 is a block diagram showing how a ring tone is determined for an incoming call.

### DETAILED DESCRIPTION

Several preferred embodiments of the present invention will now be described with reference to the accompanying drawings. Various other embodiments of the invention are also possible and practical. This invention may be embodied in many different forms and the invention should not be construed as being limited to the embodiments set forth herein.

The figures listed above illustrate an embodiment of the invention and the operation of such embodiment. In the figures, the size of the boxes is not intended to represent the size of the various physical components. Where the same element appears in multiple figures, the same reference numeral is used to denote the element in all of the figures where it appears.

Only those parts of the various units are shown and described which are necessary to convey an understanding of the embodiment to those skilled in the art. Those parts and elements not shown are conventional and known in the art. The following simple example illustrates some aspects of the present invention. For this example consider an MDN telephone line that has three telephone numbers; a main number 444.444.4401 (for business) and two subsidiary number, 444.444.4402 (for general use), and 444.444.4403 (for the children's use). Without the present invention all calls from this MDN line would be identified as coming from the main number 444.444.4401.

With the present invention, an association table is established. The association table can associate the children's number 444.444.4403 with a called number 555.555.5555. Thereafter any calls from the MDN line to the 555.555.5555 number would be indicated as having originated from the children's number 444.444.4403.

Herein the term “association table” is used to describe the data base that associates a called number with a particular calling number. However, the data base that is maintained to associate particular MDN numbers with particular called numbers can be referred to and described as “an association table”, “an association list”, “a buddy list”, “an acquaintance list” or by various other names. Herein the name “association table” is used; however, it should be understood that the name “association table” refers to any list, table, profile, or data base, such as that maintained by the described embodiments, and that the name used to describe the list, table, profile or data base is of no particular significance.

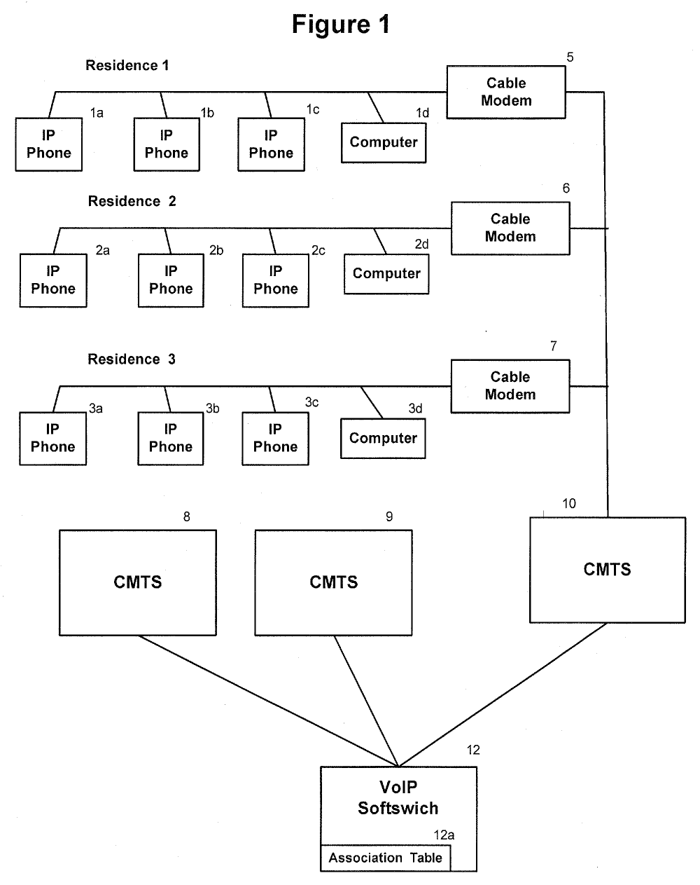

FIG. 1 is an overall diagram of a first preferred embodiment of the invention. There are three representative residences identified as residences, designated 1, 2 and 3 in this embodiment. Only three residences are specifically shown and discussed; however, other embodiments can have any number of residences up to other conventional capacity limits of a system. The telephones in residence 1 are identified as 1a, 1b and 1c. The telephones in residence 2 are identified as 2a, 2b, and 2c. The telephones in residence 3 are identified as 3a, 3b, and 3c. Each of the three residences also has a conventional personal computer, respectively identified as 1d, 2d and 3d. It is noted that three telephones are shown in each residence; however, this is an arbitrary number. Some residences could for example have only one telephone and yet the line to that residence can be an MDN line with multiple numbers. Thus, each residence may have any number of individual telephones and any number of MDN numbers.

The VoIP telephones and the personal computer in each residence are connected by conventional cables to a cable modem in the residence. The VoIP telephones and the computer in residence 1 are connected to the cable modem 5, the VoIP telephones and the computer in residence 2 are connected to the cable modem 6, and the VoIP telephones and the computer in residence 3 are connected to the cable modem 7. Each of the cable modems is connected to a conventional cable modem termination system (CMTS) 10 by a conventional coaxial cable.

Systems that have a number of VoIP telephones and a computer connected to a cable modem and that have a cable modem connected to a CMTS system are conventional. Such systems are in widespread use.

The CMTS is in turn connected to a VoIP softswitch 12 that includes an association table 12a. The term softswitch is a term that is widely used and it is a combination of the words “software” and “switch”. As is conventional softswitch 12 provides call control and service intelligence telephony. It is noted that a softswitch 12 can also serve as a platform for interfacing applications and enhanced service platforms. The softswitch 12, other than association table 12a and the additional programming associated therewith, can for example be the type of softswitch marked by Cisco Systems Inc as the “Cisco BTS 10200 Softswitch”.

The softswitch 12 includes special additional programming 23a and an association table 12a that are not part of the commercially available softswitches. The association table 12a and the associated programming 23a are explained below.

As is conventional, the softswitch 12 is connected to a number of CMTS units. That is in addition to being connected to CMTS 10, softswitch 12 is connected to two other CMTS units 8 and 9, as shown in FIG. 1. The configuration shown in FIG. 1 is merely representative. For convenience of illustration and explanation, FIG. 1 illustrates only a small number of VoIP telephones since this is a sufficient number to explain the present invention. Other embodiments include various numbers on VoIP telephones, cable modems and CMTS systems as is appropriate for each particular application.

Each residence has the equivalent of a single telephone line; however, there can be multiple directory entries for the telephone line to each residence. That is, there can be multiple telephone numbers assigned to the single telephone line in each residence. When the telephone line in any particular residence is called, all the telephones in that residence ring. That is, when any of the telephone numbers assigned to the telephone line in each residence is called all the telephones in that residence ring. The ring tone can be different for each number assigned to a particular telephone line. Thus, one can tell which telephone number is being called. Such a service is commercially available. It is sometimes referred to as a “teen service” or as multiple director numbers (MDN) service.

As explained above, each residence has a “main telephone number” and the telephone line to the residence is identified by this number. This main telephone number is herein alternately referred to as the main MDN number. In prior art systems, all calls originating in a residence where identified as coming from or originating at this main telephone number. With the present invention, calls can be identified as coming from anyone of the multiple numbers assigned to a residence. This is accomplished using the association table as described below.

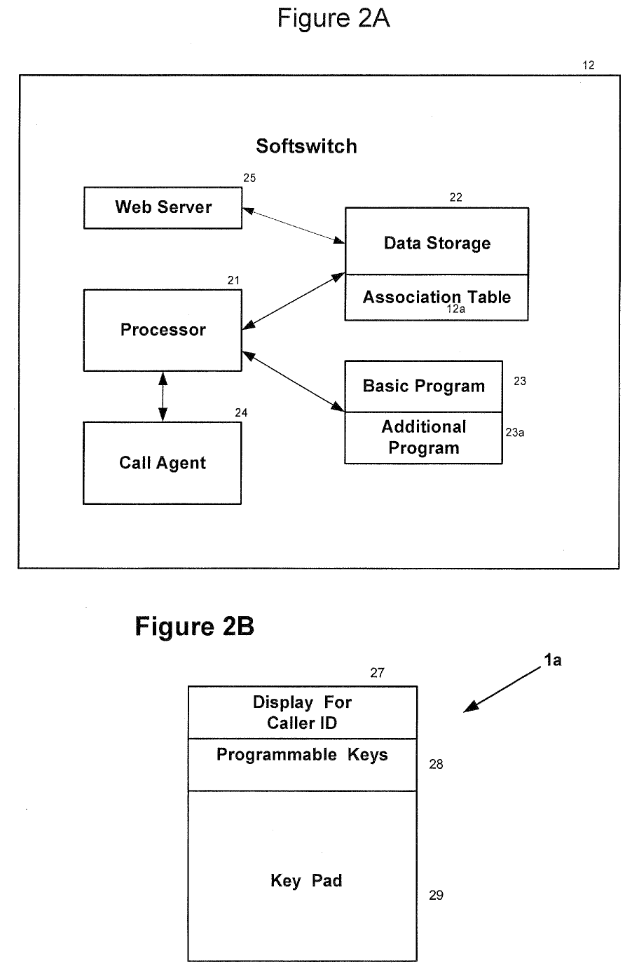

FIG. 2A illustrates the relevant parts of softswitch 12. Those parts not shown (and some of the parts that are shown) are conventional. The softswitch 12 includes a processor 21, data storage 22, programs 23, a call agent 24 and a web server 25. The web server 25 can store and retrieve information or data from or to data storage 22. The data storage 22 stores a profile for each of the IP telephones connected to the system as is conventional. The data storage 22 also includes an association table 12a that has space for entries for each of the VoIP telephones connected to the system. The processor 21 executes conventional programs 23 and the additional programming 23a that is used in connection with association table 12a. The additional programming 23a could alternately be considered and identified as additional feature logic for the softswitch. The call agent 21 sets up calls as is conventional and performs the other conventional operations performed by a call agent. The conventional operations performed by call agent 24 are augmented by the operations related to association table 12a as described below.

FIG. 2B shows the relevant parts of IP telephone 1a. The other IP phones are identical to telephone 1a. Each IP telephone has a display 27 that shows the number of the calling telephone. The IP telephones also have programmable or soft keys 28 and a key pad 29.

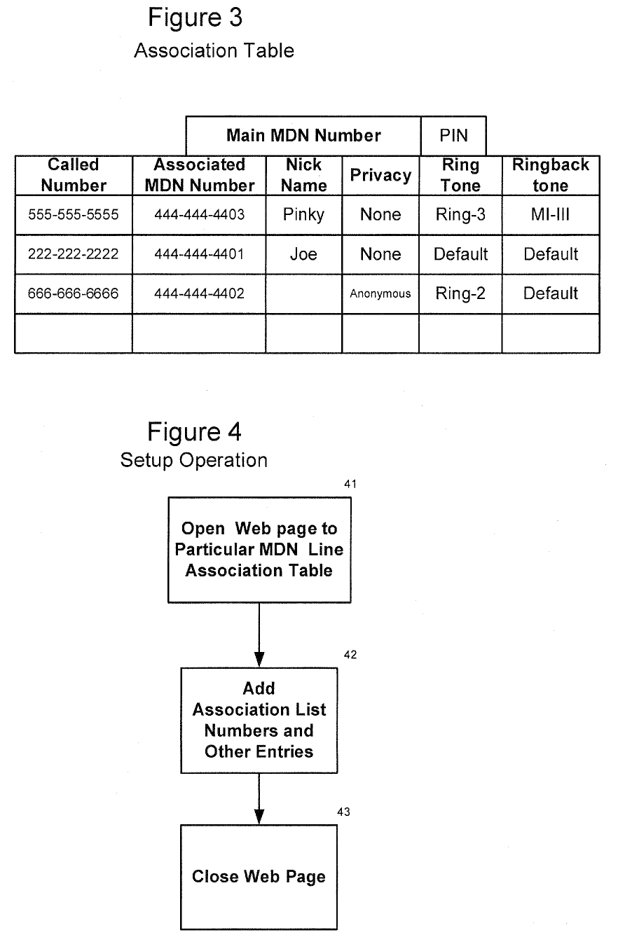

An example of an association table 12a is illustrated in FIG. 3. The system includes an association table for each main MDN number serviced by the system. That is, each association table is related to a particular main MDN number. In order to enter or change data in the table, the table can be accessed using a web page on server 25. Such access is conventional. The table is accessed in order to enter or change data in the table using the main MDN number with which the table is associated; however, in order to access the page one must enter the correct PIN that is stored in the table (or elsewhere) as is conventional for PIN access.

Each association table has entries that associate called numbers with particular MDN numbers on the MDN telephone line. For example, in the specific association table shown in FIG. 3, the main number of the MDN line is 444-444-4401. The called number 555-555-5555 is associated with the MDN number 444-444-4403. Thus, calls to the number 555-555-5555 will be identified as coming from the number 444-444-4403.

The association table can also store other information for association with particular called numbers. As shown in FIG. 3, the association table can include: (1) a particular nickname, for example “Pinky” that can be used to identify the calling party, (2) if a “privacy” condition should be established for a particular called number, (3) what ring tone should be used for the number, and (4) an indication of a custom ring back tone that should be used by a particular called number. It should be understood that the information shown in FIG. 3 is merely exemplary and the association table can be used to store any useful information relative to particular numbers called from an MDN line.

FIG. 4 is a block diagram illustrating one particular way that data can be entered into the association table 22a. It is noted that data can also be entered into association table 22a in various other ways as described below.

Data can be entered into association table 12a from personal computers 1d, 2d and 3d, via the web server 25. By entering a main MDN number and the appropriate PIN as indicated block 41, a user can access the table via web server 25. Numbers can be entered and associated with particular MDN numbers as indicated by block 42. Finally the web page can be closed as indicated by block 43 and the data stored in the appropriate association table. Accessing a stored table in this manner is conventional and it can be performed in various other ways.

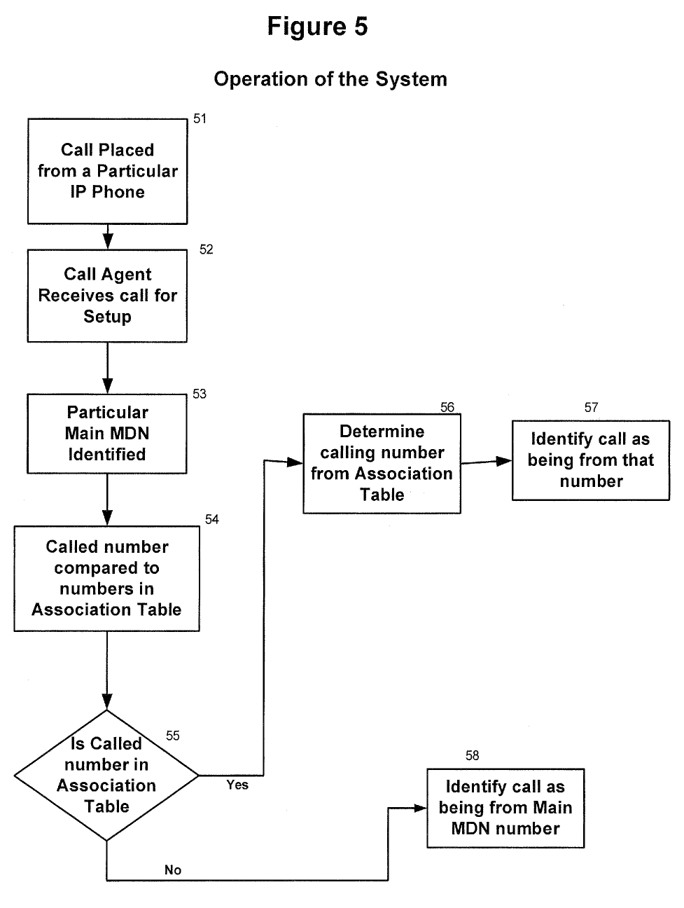

FIG. 5 is a block diagram illustrating the operation of the system. The operations illustrated in FIG. 5 take place after an association table has been established. The operation begins when a call is placed from a particular IP telephone on an MDN line as indicated by block 51. The call is received by the call agent in softswitch 12 and identified in a conventional manner as coming from the main MDN telephone line number of the telephone line that originated the call as indicated by block 53.

At this point in the process several operations that are not conventional begin. The called number is compared to the numbers in the association table of the MDN line from which the call originated as indicated by block 54. Next, as indicated by block 55 a decision is made as to whether or not the called number is in the association table. If the called number is not in the association table, the call is identified as coming from the Main MDN line number as indicated by block 58.

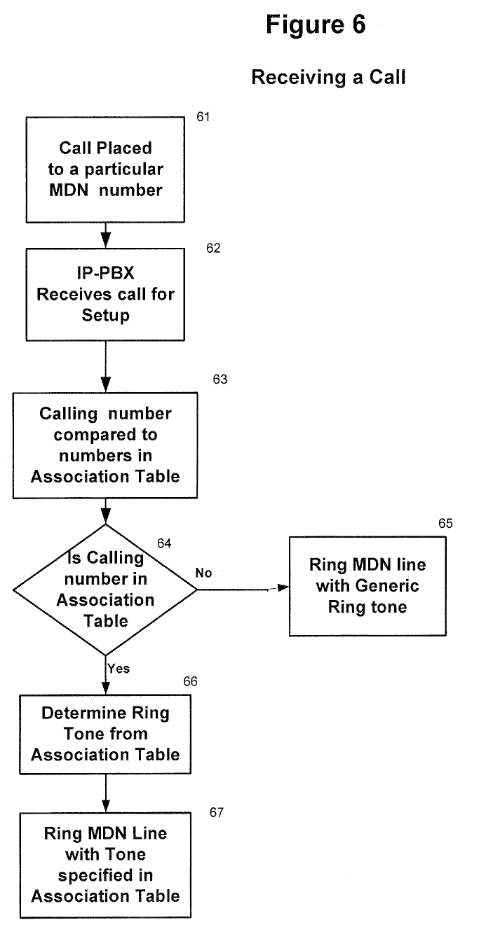

If the called number is in the association table, the operations indicated by block 56 and 57 take place. First as indicated by block 56, a determination is made as to which MDN number on the MDN line is associated with the called number. Next as identified by block 57, the call is identified as coming from the particular MDN number associated with the called number. That is, the particular MDN number associated with the called number is provided to the call agent 24 and used in place of the main number of the MDN line as the calling number. FIG. 6 illustrates how the ring tone for an incoming call is determined. Blocks 61 and 62 illustrate a call coming into IP-PBX 12 in a conventional manner. At this point as indicated by block 63, the calling number is compared to numbers in the association table for the MDN line being called. Block 64 indicates the decision process of determining if the calling number is in the association table. If the calling number is in the association table for an MDN numbers, the ring tone specified by the association table is used as indicated by block 66 and 67. If the calling number is not in the association table, a generic ring tone is used as indicated by block 65.

It is noted that associating a called number with a particular telephone number as described above can be used for various other purposes in addition to call identification. The MDN number associated with a called number can be used for any purpose that a conventional softswitch uses the identity of a calling number. For example if the called telephone has automatic call rejection (ACR) enabled, the MDN number associated with the called number in the association table can be used to remove such screening.

The association table can include additional data related to each called number as illustrated in FIG. 3. This additional data can be used to assign special properties to each called number. For example, a different nickname can be used to identify the calling party for some or all of the called parties. In other embodiments, this additional data can be used to specify that for some called parties, the calling party can be identified as an anonymous caller. A field in the Association Table can also be used to specify different ringback tones for particular called parties. In such an embodiment, there would be an additional step in the operations shown in FIG. 6. This addition step would determine the ringback tone for a calling party whose number is in the association table. Various and other features can be assigned to each called party identified in the association table.

It is noted that the association table can be accessed and populated via a conventional web page as described above. However, in other alternate embodiments, the numbers are placed in the association table as follows: After a particular number is called from an MDN line, the caller presses a special key, for example the * key. Then the caller would dial a PIN and if the PIN is accepted, the caller would dial the particular MDN number from which the call is being made. This would place the called number in the association table.

It is noted that the invention can be used with MDN lines that are in VoIP systems or in various other types of telephone systems. For example in other embodiments, the invention can be applied to MDN lines in POTS type of land line telephone systems, in DSL systems, in TDM systems, in fiber optic systems, and various other types of telephone systems.

It should also be noted that herein the terms “telephone number” and “number” are herein used interchangeably.

In the embodiments shown, a number being called from an MDN line can only be associated with one MDN number. An automated check can be added to the setup operation shown in FIG. 4, to insure that a called number can only be associated with one MDN number. In an alternate embodiment, a called number can be associated with more than one MDN number by special provisions such requiring the caller to enter additional data by pressing special keys when a called number is associated with more than one MDN number.

While the invention has been shown and described with respect to preferred embodiments thereof, it should be understood that a wide variety of other embodiments are possible without departing from the scope and sprit of the invention. The scope of the invention is only limited by the appended claims.

1) A method of handling calls from a Multiple Directory Number (MDN) telephone line to various called telephone numbers, said MDN telephone line having a plurality of associated MDN numbers, said method comprising the steps of:
searching an association table to determine if the called telephone number is registered in said association table,
if the called telephone number is in the association table, determining which particular MDN number on the MDN line that placed the call is associated with the called telephone number in the association table, and
identifying said particular MDN number to the called number as being the calling MDN number.

2) The method recited in claim 1 wherein said telephone system is a Voice over IP (VoIP) telephone system.

3) The method recited in claim 1 wherein said telephone system is a POTS telephone system.

4) The method recited in claim 1 wherein said association table stored information concerning what ring tone should be used for calls to particular called MDN numbers.

5) The method recited in claim 1 wherein said association table stores information concerning what ringback tone should be used for calls from particular calling numbers.

6) A method of handling calls from a telephone line that has multiple Directory Numbers (MDN) associated therewith, to various called telephone numbers comprising the steps of:
searching an association table to determine if the called number is registered in said association table,
if the called number is in the association table, determining which particular MDN number is associated with the called number in the association table, and
using the particular MDN number determined from said association table to determine how the call to the particular called number should be handled.

7) The method recited in claim 6, including identifying the calling telephone number as the particular calling number associated with the called number in the association table.

8) The method recited in claim 6 wherein said telephone line is a multiple directory number (MDN) line.

9) The method recited in claim 6 wherein said telephone system is a Voice over IP (VoIP) telephone system.

10) The method recited in claim 6 wherein said telephone system is a POTS telephone system.

11) The method recited in claim 6 wherein said telephone system is a Voice over IP (VoIP) telephone system and wherein said calling telephone number is a number for a telephone on a Multiple Directory Number telephone line.

12) The method recited in claim 6 wherein said telephone system is a Voice over IP (VoIP) telephone system and wherein said calling telephone number is a Multiple Directory Number on a telephone line connected to a cable modem.

13) The method recited in claim 6 wherein said telephone system is a Voice over IP (VoIP) telephone system, wherein said calling telephone number is a Multiple Directory Number, and wherein said calling number originates from a line that has multiple telephone numbers assigned to said telephone line.

14) A system for identifying a calling telephone number on a Multiple Directory Number (MDN) line, said MDN line having associated therewith multiple MDN telephone numbers, said system comprising:
a telephone switch which receives a telephone call from said MDN line and which has stored therein an association table that associates called telephone numbers with particular MDN telephone numbers on said MDN line, and
a calling number identification subsystem that identifies a calling telephone number as the MDN telephone number associated with the called number in said association table.

15) The system recited in claim 14 wherein said system is a Voice over Internet Protocol (VoIP) telephone system.

16) The system recited in claim 14 wherein said telephone switch is a softswitch.

17) The system recited in claim 14 wherein said association table stores information indicating which ring tone should be used for said called number.

18) The system recited in claim 14 wherein said association table stores information indicating the nickname that should be used to identify the calling to a particular called number.

19) Logic for handling a telephone call from a Multiple Directory Number (MDN) telephone line that has multiple MDN telephone numbers, said logic encoded in one or more media for execution and when executed operable to:
search an association table to determine if the called number is registered in said association table,
if the called number is in the association table, determine which particular MDN telephone number on the MDN line that placed the call is associated with the called number in the association table, and
identify the calling telephone number to the called number as being the particular calling MDN telephone number associated with the called number in the association table.

20) The logic recited in claim 19 wherein said logic when executed is operable to search said association table for information concerning how a call to said called number should be handled.
